(19) United States
(12) Patent Application Publication
(10) Pub. No.: US 2005/0198015 A1
(43) Pub. Date: Sep. 8, 2005

(54) METHOD AND SYSTEM FOR PRESENCE-TECHNOLOGY-BASED INSTANTLY SHARED CONCURRENT PERSONAL PREFERENCE INFORMATION FOR INTERNET-CONNECTED TV

(75) Inventors: M. Ibrahim SEZAN, Camas, WA (US); George Rome BORDEN, Portland, OR (US); Gary A. FEATHER, Camas, WA (US); Mick GROVER, Portland, OR (US)

Correspondence Address: DAVID C RIPMA, PATENT COUNSEL;SHARP LABORATORIES OF AMERICA, 5750 NW PACIFIC RIM BLVD, CAMAS, WA, 98607, US

(73) Assignee: SHARP LABORATORIES OF AMERICA, Camas, WA (US)

(21) Appl. No.: 10/906,754

(22) Filed: Mar. 4, 2005

Related U.S. Application Data
(60) Provisional application No. 60/550,301, filed on Mar. 4, 2004.

(51) Int. Cl. G06F 7/00

(52) U.S. Cl. 707/3

(57) ABSTRACT

A presence-based collaboration system includes a storage containing concurrent-content-consumption information for at least one user of a community of users, and a processor that generates filtered concurrent-content-consumption information for at least one user of the community of users that is based on the concurrent-content-consumption information contained in the storage and on user permission information for at least one user of the community of users. The permission information of each user of the system includes information relating to the concurrent-content-consumption information for the user that is presented to at least one other user of the community of users. In one exemplary embodiment, the presence-based collaboration system also includes a plurality of content terminals that communicate on a client/server basis with the presence-based collaboration system. In another exemplary embodiment of the present invention, the presence-based collaboration system communicates with another presence-based collaboration system on a peer-to-peer basis.

### CROSS-REFERRENCE TO RELATED APPLICATION

The present application claims priority to U.S. Provisional Patent Application Ser. No. 60/550,301, filed Mar. 4, 2004, invented by M. Ibrahim Sezan et al., entitled “Method and System For Presence-Technology Based Instantly Shared Concurrent Personal Preference Information For Internet Connected TV,” and which is incorporated by reference herein.

### BACKGROUND OF THE INVENTION

1. Field of the Invention

The present invention relates to presence information systems. In particular, the present invention relates to a system and a method for presenting to a user concurrent-content-consumption information of a community of users.

2. Description of the Related Art

Conventional automatic user profiling, preference-based filtering, and recommendation engine technologies enable automatic dynamic updating of user content-preference profiles on the basis of usage history. See, for example, M. Ferman et al., “Multimedia content recommendation engine with automatic inference of user preferences,” in Proceedings of ICIP 2003 Conference, September 2003. Conventional automatic schemes perform regular updates and provide up-to-date and meaningful recommendations to a user over time, even when the user sets a content-preference profile only once or infrequently. The resulting content-preference profile is, nevertheless, ultimately limited to the content preferences of the user, and there is little chance for the user to discover “new tastes” and “new favorites” based solely on the content-preference profile of the user.

Conventional collaborative filtering techniques can be utilized for expanding a recommendation list that is generated based solely on a content-preference profile of a user. For example, an on-line book purchaser could be presented with a list of suggested books that were also purchased by purchasers of a book being considered for purchase. Because the list of suggested books is based on the purchase preferences of other book purchasers, the suggested list expands on a recommendation list that would otherwise be generated based solely on the preference profile of the book purchaser. Conventional collaborative filtering techniques are, however, usually implemented in an anonymous manner with no indication of the identities of the other purchasers forming the collaborative community and/or with no indication of the individual or collective preferences of the other purchasers forming the collaborative community.

Conventional collaborative-filtering techniques also do not reflect what other users are instantaneously consuming. For example, information forming the basis for a suggested book list may actually be based on information that is several years old. Further still, conventional collaborative-filtering techniques do not provide any indication whether the people forming the collaborative community have any commonality of interests other than being, for example, the purchaser of a particular book.

Consequently, what is needed is a way to expand a recommendation list so that it includes concurrent preferences of a collaborative community. Additionally, what is needed is a way to expand a recommendation list based on both concurrent individual and/or collective consumption selections of a collaborative community at any instant in time.

### SUMMARY OF THE INVENTION

The present invention provides a way to expand a recommendation list so that it includes concurrent preferences of a collaborative community. Additionally, the present invention provides a way to expand a recommendation list based on both concurrent individual and collective consumption selections of a collaborative community at any instant in time.

The present invention provides a presence-based collaboration system includes a storage that contains concurrent-content-consumption information for at least one user of a community of users, and a processor that generates filtered concurrent-content-consumption information for at least one user of the community of users. The filtered concurrent-content-consumption information for each user of the community of users is based on the concurrent-content-consumption information contained in the storage and based on user permission information for at least one user of the community of users. The permission information of each user of the system includes information relating to the concurrent-content-consumption information for the user that is presented to at least one other user of the community of users. The community of users could be a predetermined community of users, a community of users that is selectable by a user of the system from a plurality of predetermined communities of users, or a community of users in which each member of the community of users is selectable by the user of the system. The filtered concurrent-content-consumption information can include an indication of content being consumed by the community of users based on a degree of popularity of the content and/or an indication of content being concurrently consumed by at least one user of the community of users. Alternatively or additionally, the filtered concurrent-content-consumption information can include an indication of content matching a predetermined content preference of a user of the system that is being consumed by at least one other user of the community of users, an indication of content being consumed by a majority of the community of users, and/or an indication of content being consumed by each user of the community of users.

In one exemplary embodiment, the presence-based collaboration system also includes a plurality of content terminals that are coupled to the presence-based collaboration system through a communications network. Each content terminal communicates with the presence-based collaboration system as a client-type system with respect to the presence-based collaboration system. At least one content terminal presents to a user of the system filtered concurrent-content-consumption information generated for at least one user of the community of users. At least one content terminal could be a personal computer, a laptop computer, a handheld computer, or a device that presents one of audio and visual content to a user. According to the present invention, a user at one content terminal can communicate with at least one other user of the community of users using an instant-messaging technique.

In another exemplary embodiment of the present invention, there is at least one other presence-based collaboration system, such that each presence-based collaboration system communicates with another presence-based collaboration system on a peer-to-peer basis over a communications network. Accordingly, the storage for each respective presence-based collaboration system contains concurrent-content-consumption information for a user of the presence-based collaboration system, and the filtered concurrent-content-consumption information generated for each user of the community of users is based on the concurrent-content-consumption information contained in the storage of the presence-based collaboration system and is based on user permission information for at least one user of the presence-based collaboration system. A user at one presence-based collaboration system can communicate with at least one other user of the community of users using an instant messaging technique.

The present invention also provides a content terminal having a storage and a processor. The storage contains permission information for at least one user of the content terminal. The permission information includes information relating to concurrent-content-consumption information for the user that is presented to at least one other user of a community of users. The permission information of each user of the content terminal also includes information relating to the concurrent-content-consumption information for the user that is presented to at least one other user of the community of users. The processor receives filtered concurrent-content-consumption information for at least one other user of the community of users, such that the filtered concurrent-content-consumption information for the other user is based on user permission information for the other user. The community of users can be a predetermined community of users, a community of users that is selectable by a user of the system from a plurality of predetermined communities of users, or a community of users in which each member of the community of users is selectable by the user of the system. The filtered concurrent-content-consumption information can include an indication of content being consumed by the community of users based on a degree of popularity of the content and/or an indication of content being concurrently consumed by at least one user of the community of users. The filtered concurrent-content-consumption information could also an indication of content matching a predetermined content preference of a user of the content terminal that is being consumed by at least one other user of the community of users, an indication of content being consumed by a majority of the community of users, and/or an indication of content being consumed by each user of the community of users.

In one exemplary embodiment, the content terminal is coupled to a presence-based collaboration system through a communications network and communicates with the presence-based collaboration system as a client-type system. Accordingly, the content terminal sends the filtered concurrent-content-consumption information for a user of the content terminal to the presence-based collaboration system. In another exemplary embodiment, the content terminal receives the filtered concurrent-content-consumption selection information from another content terminal on a peer-to-peer basis.

The present invention also provides a method in which concurrent-content-consumption information for at least one user of a community of users is received, and filtered concurrent-content-consumption selection information is generated for at least one user of the community of users such that the filtered concurrent-content-consumption information for each user of the community of users is based on the received concurrent-content-consumption information and based on user permission information for at least one user of the community of users. The permission information of each user of the system includes information relating to the concurrent-content-consumption information for the user that is presented to at least one other user of the community of users. In one exemplary embodiment, the filtered concurrent-content-consumption information is communicated to other users of the community on a client-server basis. In an alternative exemplary embodiment, the filtered concurrent-content-consumption information is communicated to other users of the community on a peer-to-peer basis.

### BRIEF DESCRIPTION OF THE DRAWINGS

The present invention is illustrated by way of example and not by limitation in the accompanying figures in which like reference numerals indicate similar elements and in which:

FIG. 1 depicts a functional block diagram of an exemplary embodiment of a presence-based shared-concurrent-content-consumption system according to the present invention;

FIG. 2 depicts a functional block diagram of an exemplary presence-based collaborative server according to the present invention;

FIG. 3 depicts a functional block diagram of an exemplary embodiment of a network-connected content terminal (NCCT) according to the present invention;

FIG. 4 depicts a flowchart of a process for setting up participation in community for sharing concurrent-content-consumption information according to the present invention; and

FIG. 5 depicts a flowchart of a process for sharing of concurrent-content-consumption information performed by a presence collaboration engine according to the present invention.

### DETAILED DESCRIPTION OF THE PRESENT INVENTION

The present invention utilizes collaborative filtering in a presence-technology infrastructure for providing concurrent-content-consumption information relating to audio, video, textual and/or graphical content selections that each member (or user) of a community is consuming at any given instant in time. Accordingly, the present invention enables expanded content discovery of audio, video, textual and/or graphical content by sharing concurrent-content-consumption information among members of a community. Additionally, the present invention provides a member with a sense of community as audio, video, textual and/or graphical content is being consumed. As used herein, the terms “consumption” and “consume” refer to user actions that include watching, viewing, recording, listening, playing, interacting, etc., with an audio, video, textual and/or graphical content.

The present invention allows, for example, one member of a community to learn not only that a second member of the community is at home and watching television, but that the second member is watching, for example, the movie entitled “The Great Escape.” The first member may then decide to watch the same movie, unless, of course, the first member is already watching the same movie. Thus, a content-preference profile for the first member that is automatically updated based on a personal selection history of the member can be further expanded based on a concurrent personal consumption selection of another member of the community. Additionally, the first member may decide to initiate an audio-based, video-based, and/or a text-based chat session with the second member in order to chat about the movie, for example, during the movie or later after viewing the movie.

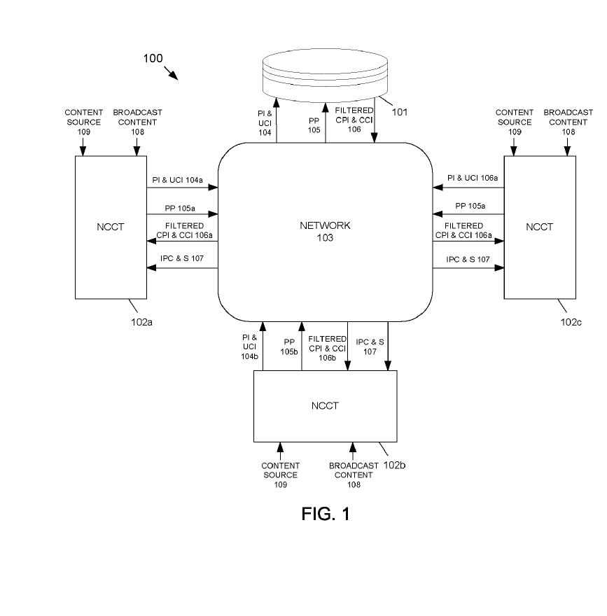

FIG. 1 depicts a functional block diagram of an exemplary embodiment of a distributed presence-based shared-concurrent-content-consumption system 100 according to the present invention. System 100 is configured in a client-server-based topology that includes a presence-based collaboration server 101 that is communicatively coupled in a well-known manner to a plurality of network-coupled content terminals (NCCT) 102 through a communications network 103, such as the Internet. Each NCCT 102 presents audio, video, textual and/or graphical content to a user of the NCCT. That is, a user can consume audio, video, textual and/or graphical content on an NCCT 102. In one exemplary embodiment, an NCCT 102 could be an Internet-connected television (TV). In another exemplary embodiment, an NCCT 102 could be a network-coupled personal computer (PC). In yet another exemplary embodiment, an NCCT 102 could be a handheld or a laptop computer that is coupled to network 103 via a wireless link. While FIG. 1 depicts only three NCCTs 102a-102c coupled to network 103, it should be understood that any number of NCCTs 102 could be coupled to network 103. Moreover, it should be understood that while only a single communications network 103 is depicted in FIG. 1, system 100 could alternatively be and/or be formed by a plurality of different types of networks, such as a wireless communications network, a public-switched telephone network (PSTN) and/or a cable television network.

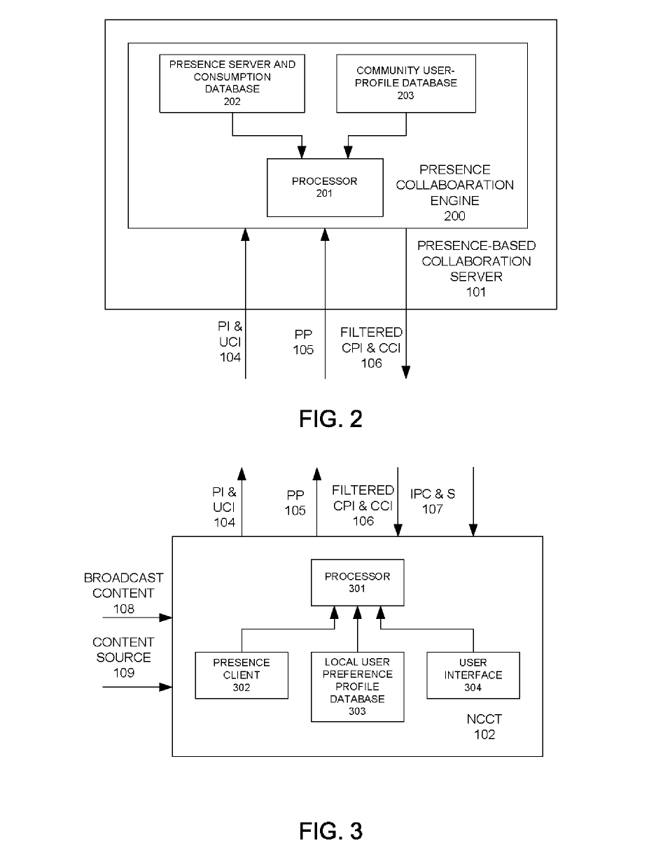

FIG. 2 depicts a functional block diagram of an exemplary presence-based collaborative server 101 according to the present invention. Presence-based collaborative server 101 includes a presence collaboration engine 200 having a processor 201, a presence server and consumption database 202 and a community user-profile database 203. Presence collaboration engine 200 could be part of an embedded instant-messaging application. Alternatively, presence collaboration engine 200 could be a dedicated presence engine for system 100. Additionally, it should be understood that presence-based collaboration server 101 could be a server system that is dedicated to a presence-based collaborative system according to the present invention or could be part of an application server.

Presence collaboration engine 200 receives presence information (PI) and user consumption information (UCI) from each of the users of a community. Presence information (PI) and concurrent user consumption information (UCI) for each user are related and will be referred to herein as PI & UCI 104. Presence server and consumption database 202 stores PI & UCI 104 for each user of a community. The PI & UCI 104 that is received from each user is used for updating consumption database 202. In one exemplary embodiment, presence server and consumption database 202 accumulates PI & UCI 104 for each community member (based on the permission-profile information PP 105 of each user of a community, as described elsewhere herein) so that each user of the community can review past content-consumption selections of other users in order to potentially expand their respective recommendation lists. Accumulated PI & UCI 104 could be a complete historical accumulation over the entire time a community has existed, the entire time a particular user has been a community member, or could extend back in time for only a predetermined length of time. It should be understood that even though presence server and consumption database 202 is depicted as a single functional entity, the presence server functional portion and the consumption database functional portion of presence server and consumption database 202 could be embodied as separate functional entities.

Presence collaborative engine 200 also receives permission-profile information (PP) 105 from each user of a community. The received permission-profile information is stored in community user-profile database 203. In one exemplary embodiment, permission-profile information for each respective user includes information that specifies how consumption information for the user is shared with other specific members of a community, either generally or individually, and/or what content consumption information for the user is restricted from being shared with other specific members of the community. For example, the permission-profile information for user A could specify that when user A consumes science-fiction-based content, user A does not want users B, E, F and H to be specifically apprised of the content that user A is consuming, but can be apprised that an anonymous member of the community is consuming science-fiction-based content. User A might allow all other members of the community to be specifically apprised that user A is consuming science-fiction-based content. Similarly, when user B consumes cartoon-based content, the permission-profile information for user B could specify that users A, C, D and G not be apprised of the that content user B is consuming, but that all other members of the community can be apprised that an anonymous member of the community is consuming cartoon-based content.

In another exemplary embodiment, permission-profile information could also include content-preference information for each user of a community.

While the consumption database portion of presence server and consumption database 202 and community user-profile database 203 are depicted as separate functional entities, it should be understood that the consumption database portion of presence server and consumption database 202 and community user-profile profile database 203 could be combined and embodied in a single database structure.

Processor 201 generates filtered community-presence information (CPI) and community-consumption information (CCI) 106 (herein referred to as filtered CPI & CCI 106) for each respective user based on (1) the presence and concurrent-consumption information contained in the database of presence server and consumption database 202 and (2) the permission-profile information contained in community user profile database 203. Thus, filtered CPI & CCI 106 for each respective user generally varies for each user based on user preference-profile information differences.

PI & UCI 104, PP 105 and filtered CPI & CCI 106 are routed between presence server 101 and each NCCT 102 using, for example, conventional presence protocols, such as the session initiation protocol (SIP) instant messaging and presence leveraging extensions (SIMPLE) protocol and the extensible messaging and presence protocol (XMPP), as defined by the Internet Engineering Task Force (IETF).

FIG. 3 depicts a functional block diagram of an exemplary embodiment of an NCCT 102 according to the present invention. An NCCT 102 includes a processor 301, a presence client 302, a local user preference profile database 303, and a user interface 304. Presence client 302 operates in a well-known manner in conjunction with the presence server functional portion of presence server and consumption database 202 of presence collaboration engine 200 (FIG. 2). Presence client 302 provides presence information and user consumption information (PI & UCI) 104 relating to a user of NCCT 102 to presence collaboration engine 200. In one exemplary embodiment of the present invention, the UCI portion of PI & UCI 104 is provided to presence collaboration engine 200 after a short delay to reduce communication traffic between an NCCT 102 and presence collaboration engine 200 and to avoid “bombarding” other community members with UCI updates when, for example, a user “channel surfs” between audio, video, textual and/or graphical contents. The processor 301 is programmed to introduce this delay. Presence client 302 could be part of an embedded instant-messaging application. Alternatively, presence client 302 could be part of a dedicated presence system for system 100.

Local user preference profile database 303 contains user preference-profile information for each respective user of NCCT 102 that is associated with a community. User preference-profile information includes permission information that specifies how consumption information for the user is shared with other specific members, either generally or individually, of a community to which a user belongs, and/or what presence information and content consumption information for the user is restricted from being shared with other specific members of the community. Additionally, permission-profile information can include information relating to presence information and/or content consumption information that are completely restricted from being shared with other members of the community to which the user belongs. That is, when a user does not want to share presence information and/or is consuming content that is restricted from being shared with any of the community to which the user belongs, the presence information and/or the content-consumption information is blocked from leaving the NCCT. Such blocking of information is implemented at the processor 301 according to user's permission profile information. Thus, a user may at anytime select to be “present” or “not present” with respect to other members of a community in a manner that is similar to a conventional instant-messaging application.

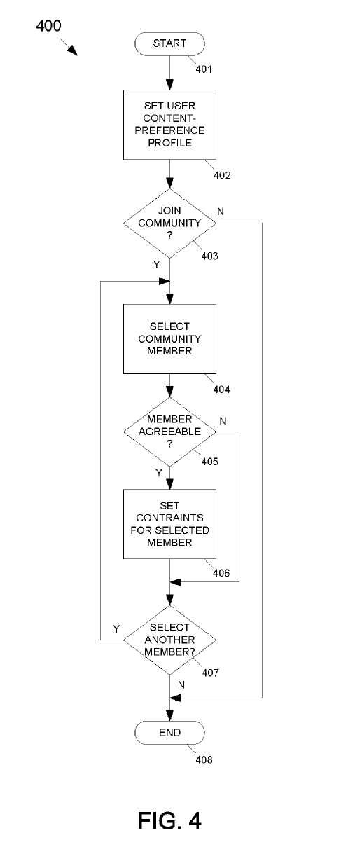

Permission-profile information can also specify the other users with which a user is willing to be part of a community. The permission-profile information for a user can be set up when the user joins a community, such as described in connection with FIG. 4. Additionally, a user can change user permission-profile information settings at any time.

User preference-profile information can further include content-preference information of a user. User preference-profile information relating to permission information is sent to presence collaboration engine 200 as permission profile (PP) information 105.

Presence client 302 also receives filtered CPI & CCI 106 from presence collaboration engine 200 relating to presence information and content consumption information for other members of a community with which a user of NCCT 102 is associated. Accordingly, the filtered CPI & CCI 106 received by NCCT 102 generally varies for each respective user based on user permission profile differences contained in community user profile database 203 (FIG. 2) and local user preference profile database 303 contained in other NCCTs.

NCCT 102 receives IP (Internet Protocol) content, i.e., content that is transported according to IP protocol, and services (IPC&S) 107, broadcast content 108 and/or content from content source 109 (such as from a DVD/VCR player, a CD player and/or any such similar local content source) that can be consumed by a user of NCCT 102. IPC&S 107, broadcast content 108 and content from content source 109 includes video content, audio content (such as music), textual content (such as an ebook), graphical, interactive games, and presence services, such as instant messaging, that are presented to a user through user interface 304. User interface 304 includes interface devices, such as displays, audio output devices, information input devices, etc., that allow a user to consume audio, video, textual and/or graphical content.

IP content and services (IPC&S) 107, broadcast content 108, and content from content source 109 include or reference content metadata associated with content. Content metadata is used in expressing UCI and filtered CCI.

The filtered CPI & CCI 106 received by an NCCT 102 is presented to a user based on the permission-profile information that is contained in community user-profile database 203 for each user consuming content. Additionally, filtered CPI & CCI 106 can be presented based on local presentation preferences of an NCCT 102. For example, titles and identification information associated with the content being consumed could be presented to a user based on metadata from, for example, an electronic program guide, or program information embedded in a broadcast television signal, such as XDS or EDS (extended data services) based on the EIA-766 standard.

In one exemplary embodiment of the present invention, the most popular content being consumed by the community of the user is indicated to the user. In another exemplary embodiment, content consumed by each respective member of the community of the user is indicated to the user. Additionally, the content consumed by each or selected members of the community could be associated with an icon representing the particular community member when the content consumption information is presented to a user. For example, one community member might be depicted with a flower icon and another might be depicted with a boat icon. Further still, consumption of a particular content can also be associated with an icon representing the content. For example, a football game could be associated with a football icon, a drama could be associated with a tragedy mask icon, and content being consumed from, for example, a DVD player or a VCR player (i.e., content source 109 in FIG. 1), could be associated with an icon representing the device sourcing the content.

In yet another exemplary embodiment, only the content being concurrently consumed by the community of the user is indicated to the user without any indication of which specific community member is consuming the content, i.e., anonymous consumption within the community. In still another exemplary embodiment, the user is provided with a special notification when a concurrent consumption matches a designated category, such as genre/actor/director, program/channel in a user's content preferences profile. For example, a user could receive a special notification that a comedy special featuring a particular favorite comedian has just been ordered by another community member, which may cause the user to select the same content.

When a user decides to consume new content, the user can do so conditionally for the first time in order not to affect the content-preference profile of the user. When the user confirms the consumption selection as a preference, the content selection is used as a basis for dynamically updating the content-references profile of the user contained in local user preference-profile database 303.

Additionally, a user of NCCT 102 can initiate an audio-, video- and/ textual-based instant-type message to one or more other users of a community based on the concurrent-content-consumption information presented by NCCT 102 to the user.

FIG. 4 depicts a flowchart 400 of a process for setting up participation in community for instantaneously sharing concurrent-content-consumption information according to the present invention. The process starts at step 401 where, for example, a user has entered into a process for setting up a user preference profile and/or a community, such as the first time an NCCT is used or at a time when the user would like to change a preference profile. At optional step 402, the user selects a content-preference profile in a well-known manner. In one exemplary embodiment of the present invention, a user content-preference profile remains static after set up unless the user re-enters the process to set up the user content-preference profile and affirmatively changes content-preference profile settings. In another exemplary embodiment, a user content-preference profile is dynamically updated after being set up based on content selections made by the user over a period of time and/or based on affirmative changes made by the user.

At step 403, the user is queried whether the user would like to join a community for sharing of concurrent-content-consumption information. If not, flow continues to step 408 where the process ends without the user joining a community and without sharing concurrent-content-consumption information.

If, at step 403, the user wants to join a community, flow continues to step 404 where the user selects another user to be part of a community that the user is creating, which could be a subset of an entire community of users participating in sharing of concurrent-content-consumption information. In one exemplary embodiment, the user is presented with a list of other users of the system that are familiar to the user, such as a buddy list of the user. In another exemplary embodiment, the user manually enters the name, screen name or moniker of each selected user. In yet another exemplary embodiment, there might be one or more established communities that a user may select to become a member, such as the community defined by the entire set of subscribers to the presence-based instant collaborative system of the present invention or a community defined by a content-preference profile.

Flow continues to step 405 where it is determined whether the selected member is agreeable to membership in the community being created by the user. For example, the permission-profile information of a member selected by the user could be queried for determining whether the selected member acquiesces to or declines membership in the community being created by the user. When the selected member declines membership, flow continues to step 407. If, at step 405, the selected member is agreeable, flow continues to step 406 where the user sets up permission-profile information with respect to the newly selected user, that is, the constraints and permission rules that specifies how consumption information for the user is shared with the newly selected user and/or what presence information and content consumption information for the user is restricted from being shared with the newly selected user. Accordingly, a user is in full control of the level of privacy regarding information sharing. In one exemplary embodiment, step 406 is not performed because a permission profile is imposed on a user when the user elects to be a member of a community, in which case the user is informed of the details of the imposed permission profile at the time the user is determining whether to become a member of the community.

Flow continues to step 407 where the user is queried whether another member should be selected for the community. If so, flow returns to step 404. If not, flow continues to step 408 where the process ends.

In another exemplary embodiment, the query at step 403 could be for a user to select membership to one or more established communities in which each community has a different set of constraints and privacy rules with respect to other members of the community. For this embodiment, steps 404-407 would not be performed.

The PP 105 so formed is communicated to the presence based collaboration server 101 at least once and when it is updated by the user over the network 103.

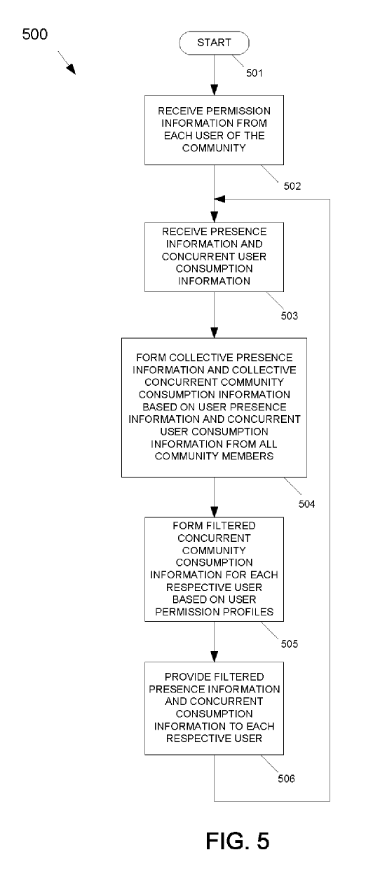

FIG. 5 depicts a flowchart 500 of a process for sharing of concurrent-content-consumption information performed by a presence collaboration engine 200 according to the present invention. The process is initiated at step 501. Flow continues to step 502 where presence collaboration engine 200 receives permission-profile information (PP) 105 from each user of a community. It should be understood that presence collaboration engine 200 could receive permission-profile information 105 at any time, which causes the contents of community user-profile database 203 to be updated. Flow continues to step 503 where presence collaboration engine 200 receives presence information and concurrent user consumption information (PI & UCI) 104. In one exemplary embodiment, the presence information and/or the user consumption information are accumulated over time. In another exemplary embodiment, the presence information and/or the user consumption information are accumulated over a defined period of time. The accumulated PI & UCI 104 could be made available to a user of the community via an appropriate interface and filtered based on the permission-profile information contained in community user-profile database 203.

Flow continues to step 504 where the collective presence information and the collective concurrent community consumption information is formed based on presence information and concurrent user consumption information (PI & UCI) 104 received from all users. Flow continues to step 505 where presence collaboration engine 200 filters the collective presence information and the collective concurrent-community-consumption information based on the permission-profile information contained in community user-profile database 203. At step 506, the filtered presence information and the filtered concurrent community consumption information are provided to each respective user. In particular, each user is provided with the community presence information and the concurrent-community-consumption information for the community and filtered by the permission-profile information specified by the user consuming the content. Presence collaboration engine 200 generates filtered presence information and filtered concurrent-community-consumption information for each user based on the permission-profile information specified by users of the system during the set-up process.

Returning to FIG. 5, flow returns to step 502 where the process continues.

While system 100, shown in FIG. 1, is depicted in a client-server-based topology, it should be understood that system 100 could be configured in a peer-to-peer-based topology. In such a configuration, the functionality of presence collaboration engine 200 and the functionality of an NCCT would be included in a peer-to-peer-based content terminal. In particular, the functionality of generating filtered concurrent-content-consumption information for each respective user of a community of users would be provided in peer-to-peer-based content terminal. Accordingly, the filtered concurrent-content-consumption information generated by a content terminal would be based on the concurrent-content-consumption information for a user of the content terminal and based on the permission-profile information for the user contained in a local user preference profile database.

Although the foregoing invention has been described in some detail for purposes of clarity of understanding, it will be apparent that certain changes and modifications may be practiced that are within the scope of the appended claims. Accordingly, the present embodiments are to be considered as illustrative and not restrictive, and the invention is not to be limited to the details given herein, but may be modified within the scope and equivalents of the appended claims.

1. A presence-based collaboration system, comprising:
a storage containing concurrent-content-consumption information for at least one user of a community of users; and
a processor generating filtered concurrent-content-consumption information for at least one user of the community of users, the filtered concurrent-content-consumption information for each user of the community of users being based on the concurrent-content-consumption information contained in the storage and based on user permission information for at least one user of the community of users.

2. The system according to claim 1, wherein the permission information of each user of the system includes information relating to the concurrent-content-consumption information for the user that is presented to at least one other user of the community of users.

3. The system according to claim 1, wherein the community of users is one of a predetermined community of users, a community of users that is selectable by a user of the system from a plurality of predetermined communities of users, and a community of users in which each member of the community of users is selectable by the user of the system.

4. The system according to claim 1, wherein the filtered concurrent-content-consumption information includes at least one of an indication of content being consumed by the community of users based on a degree of popularity of the content and an indication of content being concurrently consumed by at least one user of the community of users.

5. The system according to claim 1, wherein the filtered concurrent-content-consumption information includes at least one of an indication of content matching a predetermined content preference of a user of the system that is being consumed by at least one other user of the community of users, an indication of content being consumed by a majority of the community of users, and an indication of content being consumed by each user of the community of users.

6. The system according to claim 1, further comprising a plurality of content terminals coupled to the presence-based collaboration system through a communications network, each content terminal communicating with the presence-based collaboration system as a client-type system with respect to the presence-based collaboration system, at least one content terminal presenting to a user of the system filtered concurrent-content-consumption information generated for at least one user of the community of users.

7. The system according to claim 6, wherein at least one content terminal is one of a personal computer, a laptop computer, a handheld computer, and a device that presents one of audio and visual content to a user.

8. The system according to claim 6, wherein a user at one content terminal communicates with at least one other user of the community of users using an instant-messaging technique.

9. The system according to claim 1, further comprising at least one other presence-based collaboration system, each presence-based collaboration system communicating with another presence-based collaboration system on a peer-to-peer basis over a communications network,
wherein the storage for each respective presence-based collaboration system contains concurrent-content-consumption information for a user of the presence-based collaboration system, and
wherein the filtered concurrent-content-consumption information generated for each user of the community of users is based on the concurrent-content-consumption information contained in the storage of the presence-based collaboration system and is based on user permission information for at least one user of the presence-based collaboration system.

10. The system according to claim 9, wherein the communications network is the Internet, and
wherein at least one presence-based collaboration system is one of associated with a television set, a personal computer, a laptop computer and a handheld computer.

11. The system according to claim 9, wherein a user at one presence-based collaboration system communicates with at least one other user of the community of users using an instant messaging technique.

12. A content terminal, comprising:
a storage containing permission information for at least one user of the content terminal, the permission information including information relating to concurrent-content-consumption information for the user that is presented to at least one other user of a community of users; and
a processor receiving filtered concurrent-content-consumption information for at least one other user of the community of users, the filtered concurrent-content-consumption information for the other user being based on user permission information for the other user.

13. The content terminal according to claim 12, wherein the permission information of each user of the content terminal includes information relating to the concurrent-content-consumption information for the user that is presented to at least one other user of the community of users.

14. The content terminal according to claim 12, wherein the community of users is one of a predetermined community of users, a community of users that is selectable by a user of the system from a plurality of predetermined communities of users, and a community of users in which each member of the community of users is selectable by the user of the system.

15. The content terminal according to claim 12, wherein the filtered concurrent-content-consumption information includes at least one of an indication of content being consumed by the community of users based on a degree of popularity of the content and an indication of content being concurrently consumed by at least one user of the community of users.

16. The content terminal according to claim 12, wherein the filtered concurrent-content-consumption information includes at least one of an indication of content matching a predetermined content preference of a user of the content terminal that is being consumed by at least one other user of the community of users, an indication of content being consumed by a majority of the community of users, and an indication of content being consumed by each user of the community of users.

17. The content terminal according to claim 12, wherein the content terminal is coupled to a presence-based collaboration system through a communications network, the content terminal communicating with the presence-based collaboration system as a client-type system, and
wherein the content terminal sends the filtered concurrent-content-consumption information for a user of the content terminal to the presence-based collaboration system.

18. The content terminal according to claim 17, wherein at least one content terminal is one of a personal computer, a laptop computer, a handheld computer, and a device that presents one of audio and visual content to a user.

19. The content terminal according to claim 17, wherein a user at one content terminal communicates with at least one other user of the community of users using an instant-messaging technique.

20. The content terminal according to claim 12, wherein the content terminal receives the filtered concurrent-content-consumption selection information from another content terminal on a peer-to-peer basis.

21. The content terminal according to claim 20, wherein the communications network is the Internet, and
wherein at least one presence-based collaboration system is one of associated with a television set, a personal computer, a laptop computer and a handheld computer.

22. The content terminal according to claim 20, wherein a user at one presence-based collaboration system communicates with at least one other user of the community of users using an instant messaging technique.

23. A method, comprising:
receiving concurrent-content-consumption information for at least one user of a community of users; and
generating filtered concurrent-content-consumption selection information for at least one user of the community of users, the filtered concurrent-content-consumption information for each user of the community of users being based on the received concurrent-content-consumption information and based on user permission information for at least one user of the community of users.

24. The method according to claim 23, wherein the permission information of each user of the system includes information relating to the concurrent-content-consumption information for the user that is presented to at least one other user of the community of users.

25. The method according to claim 23, wherein the filtered concurrent-content-consumption information is communicated to other users of the community on a client-server basis.

26. The method according to claim 23, wherein the filtered concurrent-content-consumption information is communicated to other users of the community on a peer-to-peer basis.
